(19) United States
(12) Patent Application Publication
(10) Pub. No.: US 2026/0218686 A1
(43) Pub. Date: Jul. 30, 2026

(54) METHOD AND APPARATUS TO INSTALL A GEOTHERMAL HEAT EXCHANGER INTO A MAGMA POOL

(71) Applicant: David E. Mouton, Liverpool, TX (US)

(72) Inventor: David E. Mouton, Liverpool, TX (US)

(21) Appl. No.: 19/321,906

(22) Filed: Sep. 8, 2025

Related U.S. Application Data
(60) Provisional application No. 63/749,544, filed on Jan. 25, 2025.

(51) Int. Cl. F03G 4/00; E21B 41/00

(52) U.S. Cl. CPC F03G 4/029; F24T 10/20

(57) ABSTRACT

A method to penetrate, install, seal and anchor a heat-exchanger into a liquid magma pool in one trip is disclosed to harvest geothermal energy from liquid magma. The disclosed one-trip apparatus includes a drilling heat exchanger assembly comprising a lock and sealing assembly to secure the heat exchanger assembly within an in-situ casing, and an annular seal ring comprising fusible ports. The one trip apparatus further includes one or more pressure-activated float valves at the bottom of the apparatus to enable reverse circulation through the heat exchanger when the fusible ports melt due to the proximal heat of the magma. An alternate embodiment is disclosed in the event that the liquid magma pool has a solid, non-molten strata that must be penetrated to land the one-trip apparatus. The disclosed one-trip apparatus, method, and embodiments herein can also be applied in other conventional drilling operations, including drilling oil and gas wells.

### RELATED APPLICATIONS

This application claims priority to U.S. Provisional Application No. 63/749,544, filed Jan. 25, 2025. The entire contents of the above application are hereby incorporated by reference as though fully set forth herein.

### FIELD

The present invention relates to the field of devices for drilling and energy extraction, and more specifically to drilling into the earth to extract geothermal energy extraction, or other fossil fuels or energy sources.

### BACKGROUND

Solar power, wind power, and hydroelectric power are the most commonly available sources of renewable energy but are inherently unreliable due to spurious local climatic conditions; further, these methods have relatively poor power densities. In contrast, magma geothermal energy has the potential to offer higher power density and is capable of operating despite varying climatic conditions or time of day.

Despite the abundance of Magma and its viability as a source of geothermal energy, conventional systems and methods for harnessing this energy source are either unsuitable or not commercially viable.

In 1982, Sandia National Laboratories published SAND 82-2377, documenting the results of a seminal seven (7) year project to investigate the potential of extracting geothermal energy from a magma pool. Drilling tests were conducted at the Kilauea Crater in Hawaii and focused on two methods of penetrating liquid magma: (i) lowering the drill bit into the magma pool or (ii) a repetitive cycle of quench-drilling the magma pool. Although successful, issues were documented concerning sticking of the drill stem and borehole closure after the drill stem was successfully recovered due to subsequent liquefaction of the drilled borehole by the proximal heat of the liquid magma.

Further advancements for drilling into magma pools utilizing the quench-drilling method are disclosed in U.S. Pat. Nos. 11,905,797, 11,905,814 and 12,291,965. Specifically, these patents describe methods to drill into magma pools to repetitively quench-drill the magma pool with conventional circulation as disclosed in the 1982 Sandia Report.

The quench-drilling method described in the art to penetrate magma pools requires pulling the drill stem after entry into the magma pool before an extraction system can be installed. This is not a feasible methodology as the proximal heat of the liquid magma will result in liquefaction of the borehole during the time it takes to pull out of the hole, rig up and run the geothermal heat exchanger and specialized tubulars.

U.S. Pat. No. 11,905,797 attempts to address this operational issue by inserting a “fluid conduit through the wellhead and into the wellbore,” but this suggested modification is not possible while the bit is being pulled out of the hole nor when the geothermal heat exchanger and specialized tubulars are run in the hole due to lack of adequate annular clearances to insert said conduit.

To avoid the problems associated with the aforementioned quench-drilling methods, the 1982 Sandia report described a simpler method: “ . . . simply drill through the crust and release the string to fall through the melt to the bottom of the lens.” However, the 1982 Sandia report did not detail how a heat exchanger could be installed with this method without having to remove the drilling assembly. During the time it takes to remove the drilling assembly, pick up and run the heat exchanger and geothermal completion string, the borehole created in the magma pool by the quench-drilling method will be lost due to the thermal liquefaction of the borehole due to the proximal heat of the magma.

The proposed invention solves these problems in the art by creating a system that penetrates, installs, seals and anchors a permanent geothermal heat exchanger into a magma pool in one trip. The “one-trip” system penetrates the magma pool and contemporaneously deploys a heat exchanger assembly for extracting geothermal energy without the need to remove the drill stem. This method is much simpler and prevents the borehole drilled by the repetitive quench-drilling method from collapsing due to liquefaction of said borehole due to the proximal heat of the liquid magma during the lengthy interval to pull the drilling assembly and pick up and run the heat-exchanger assembly.

### BRIEF SUMMARY OF THE INVENTION

It is the object of the present invention to provide a system that converts a conventional circulating drilling assembly into a permanently anchored and metal-to-metal sealed reverse circulation high temperature alloy heat exchanger to allow for a “one-trip” geothermal heat extraction system. While the disclosed embodiments are used for geothermal heat extraction, it is anticipated that disclosed one-trip apparatus, method, and embodiments herein can also be applied in other conventional drilling operations, including drilling oil and gas wells.

The system comprises a heat exchanger installed in the in-situ casing to harvest geothermal energy from a liquid magma pool that includes an inner tube disposed within an outer tube, a locking and seal assembly for anchoring and sealing the heat exchanger to the in situ casing, and a fusible annular seal ring between the inner tube and outer tube that has at least one fusible port filled with a low-melting point material, and at least one float valve disposed at a bottom of the heat exchanger. The fusible port is operable to melt, and as a result, the conventional drilling assembly is converted by the proximal heat of the magma into a reverse circulation high temperature heat exchanger capable of producing steam to harvest the geothermal energy of magma pools.

In another embodiment, means are provided to incorporate both the annular fusible ports in conjunction with pressure-activated mechanical valves. This is accomplished by employing a hybrid annular sealing system that provides additional annular circumference to install both fusible and mechanical annular valves. This embodiment allows repetitive cycling from conventional drilling circulation to reverse circulating through the heat exchanger in the event the liquid magma pool is not continuous, as will be detailed later.

### BRIEF DESCRIPTION OF THE DRAWINGS

FIG. 1 depicts the heat exchanger assembly in accordance with embodiments of the invention, showing the assembly above the magma pool exclusive of surface pressure containment equipment (Blow-Out Preventor—BOP's).

FIG. 2 depicts the heat exchanger assembly in accordance with embodiments of the invention, drilling above the magma pool. inclusive of surface pressure containment equipment (Blow-Out Preventor—BOP's).

FIG. 3 depicts the heat exchanger assembly in accordance with embodiments of the invention when encountering liquid magma inclusive of surface pressure containment equipment (Blow-Out Preventor—BOP's).

FIG. 4 depicts the heat exchanger assembly in accordance with embodiments of the invention showing the lock and sealing assembly engaged with the in-situ casing inclusive of surface pressure containment equipment (Blow-Out Preventor—BOP's).

FIG. 5 depicts the heat exchanger assembly in accordance with embodiments of the invention with the surface pressure containment equipment (Blow-Out Preventor—BOP's) removed and replaced with a geothermal wellhead.

FIG. 6 depicts the top locking mechanism engaged with the interior surface of the in-situ casing in accordance with embodiments of the invention.

FIG. 6A depicts a focused view of the top locking mechanism showing the conical sealing ring engaged with the interior surface of the in-situ casing.

FIG. 6B is a more focused view of the top locking mechanism shown in FIG. 6A showing the serrations of the conical sealing ring engaged with the bottom ledge of the in-situ casing.

FIG. 6C is a cross-sectional view of FIG. 6 showing heat exchanger assembly installed within the in-situ casing in accordance with the embodiment of the invention.

FIG. 7 depicts an expanded sectional view of the lower locking mechanism in accordance with embodiments of the invention detailing the bottom locking mechanism.

FIG. 7A depicts a cross-section side view of FIG. 7 detailing the collet fingers and locking lips of the lower locking mechanism.

FIG. 8A depicts an isometric perspective view of the top locking mechanism showing the serrated bottom surface of the bottom ledge to enable land out of the engaging sealing surfaces in accordance with embodiments of the invention.

FIG. 8B depicts an isometric view of the top locking mechanism showing the back-up resilient sealing rings in accordance with embodiments of the invention.

FIG. 9 depicts an isometric view of a hybrid annular sealing system showing a helical member that utilizes annular fusible ports in conjunction with an annular vertical member with reverse circulating ports installed with mechanical spring-loaded valves in accordance with embodiments of the invention.

FIG. 9A is a cross-section of the fusible ports in accordance with embodiments of the invention.

FIG. 9B is a cross-section of the reverse circulating ports with mechanical spring-loaded valves in accordance with embodiments of the invention.

### DETAILED DESCRIPTION OF INVENTION

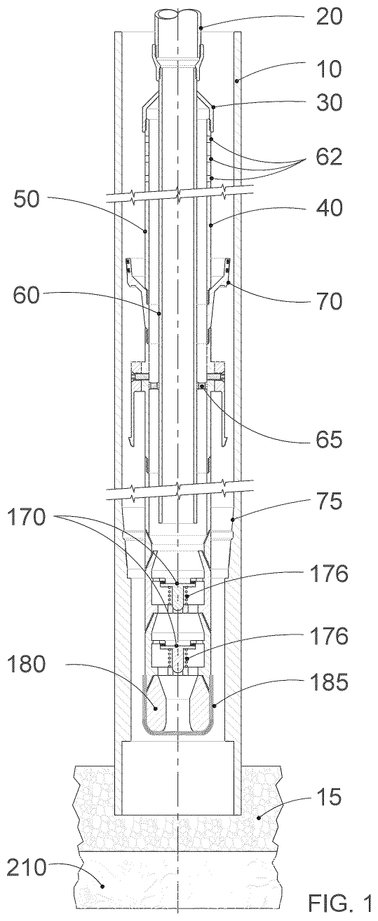

Turning to FIG. 1, a sectional view of the preferred embodiment for the heat exchanger assembly set within in-situ casing 10 is shown. The heat exchanger assembly includes geothermal completion string 20, adaptor to the heat exchanger 30, and a concentric heat exchanger 40. The concentric heat exchange 40 includes an outer tube 50, an inner tube 60, and a plurality of annular access ports 62.

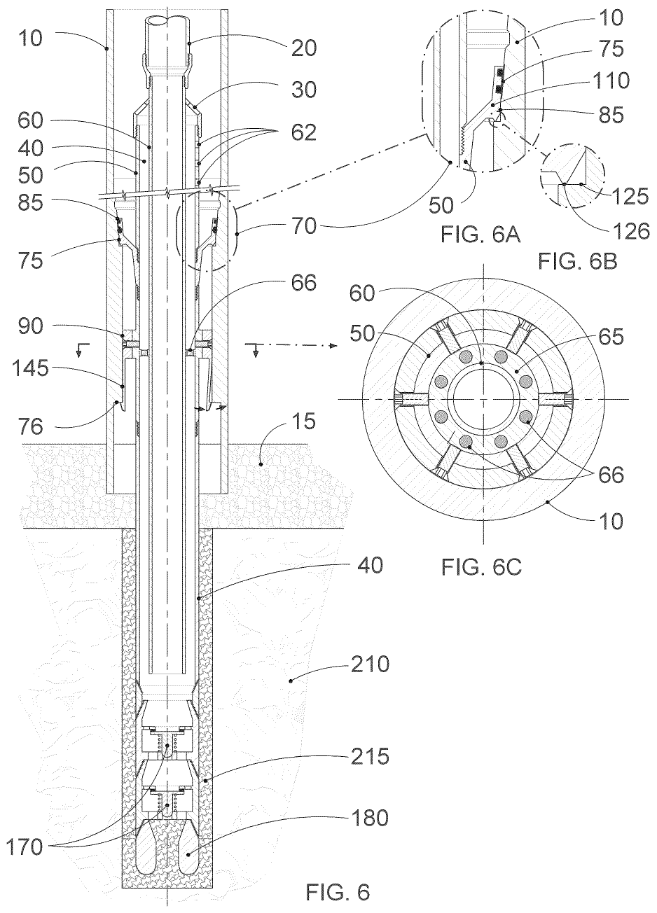

As detailed in FIG. 6 and FIG. 6C, between the inner tube 60 and outer tube 50, the heat exchanger 40 includes a fusible annular seal ring 65. The fusible annular seal ring 65 includes one or more fusible ports 66 which are filled with a low-melting point material that is operable to melt when exposed to higher temperatures produced by the proximity of liquid magma 210. For example, the material for the fusible ports 66 may include any of several low-melting point materials with melting temperatures between 600-900° F., including metals such as lead, which has a melting point around 621° F., whereas liquid magma 210 generally has a temperature of over 2,200° F., although some magma pools may have higher or lower temperatures.

The heat exchanger 40 includes a lock and sealing assembly 70 attached to an exterior surface of the outer tube 50. The lock and sealing assembly 70 is configured to secure the heat exchanger 40 to an interior mating surface profile 75 of the in-situ casing 10.

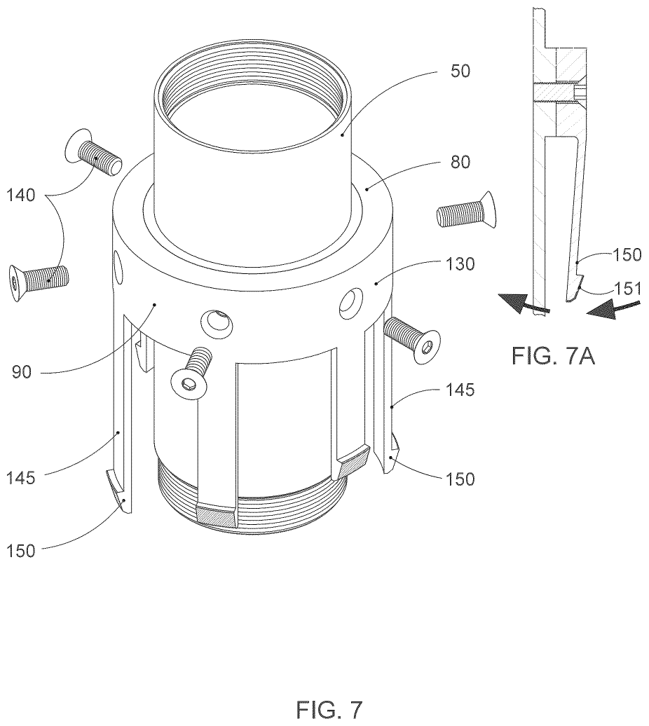

As detailed in FIGS. 6-7, an embodiment of the lock and sealing assembly 70 is shown in greater detail, which includes a top locking mechanism 85 comprised of conical sealing ring 110 as discussed below and a bottom locking mechanism 90.

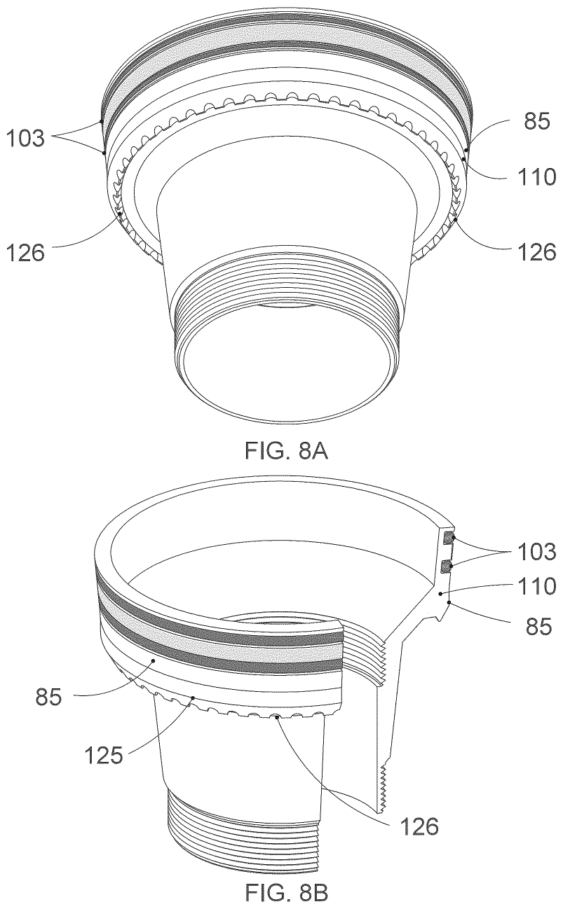

As shown in FIGS. 8A-8B, one embodiment of the top locking mechanism 85 includes a conical sealing mechanism comprising a conical sealing cone 110 with a tapered exterior surface that terminates at a bottom ledge 125, as shown in FIGS. 6A-6B. The conical sealing cone 110 forms the exterior wall which provides the means for a metal-to-metal seal between in-situ casing profile 75 and conical sealing cone 110 that may include back-up resilient sealing rings 103.

The bottom ledge 125 shown in FIGS. 6B-6C is preferably oriented so that it extends horizontally and is substantially perpendicular to the orientation of the heat exchanger 40. In addition, serrations 126 as shown in FIGS. 8A and 8B provide “junk-slots” so that debris, scale, etc. can be expended so that full contact can be made between bottom ledge 125 of the interior landing surface 75 and serrations 126.

In operation, the top locking mechanism 85 comprised of conical sealing cone 110 engages the in-situ casing 10 at the interior landing surface 75. The conical sealing cone 110 provides a metal-to-metal sealing surface that is configured to engage the interior landing surface of the in-situ casing 10 and provides the point of contact for the metal-to-metal seal. Serrations 126 contact bottom ledge 125 of interior landing surface 75 to prevent further downward movement of the lock and sealing assembly 70 when bottom locking mechanism 90 has fully engaged, as described below. The tapered exterior surface of conical sealing cone 110 is machined at a steep angle that matches the angle of the in-situ casing sealing surface 75. This provides a means of a large (approximately 10:1) vertical movement as compared to the lateral deformation of conical sealing cone 110, allowing necessary deformation of conical sealing cone 110 that results in large metal-to-metal sealing forces against the in-situ casing sealing surface 75.

Turning to FIG. 7, a preferred embodiment of bottom locking mechanism 90 is shown in detail. The bottom locking mechanism 90 is composed of a locking collet sleeve 130 that is attached to the outer body of heat exchanger 50 with a plurality of fasteners, including for example, flush mounted screws 140. A plurality of pairs of collet fingers 145 are of slightly different lengths engineered to provide a progressive locking “ratcheting” mechanism as they compress through the interior landing surface 75. As shown in FIG. 7A, locking lips 150 may have a protective nitrile or similar coating 151 to prevent scoring of interior surface 75 of in-situ casing 10 as the assembly passes through this area. Locking lips 150 prevent upward movement of the lock and sealing assembly 70 by engaging a prefabricated overhang 76 of the in-situ casing 10 as detailed in FIG. 6

As shown in FIGS. 6-7, as more downward weight is applied by lowering completion string 20 to fully engage the lock and sealing assembly 70 to in-situ casing interior surface 75 for a metal-metal seal, the corresponding pairs of collet fingers 145 expand outward and progressively lock or “ratchet” the lock and sealing assembly 70 via locking lips 150 until serrations 126 contact the bottom ledge 125 of the interior landing surface 75 to prevent downward as well as upward movement of the lock and sealing assembly 70. This provides a fully locked, metal-metal sealing system in the annulus between in-situ casing 10 and heat exchanger 40, without requiring a trip to pull the drilling assembly, run a heat exchanger and a mechanical device commonly called a “packer,” which is the established method in the art to seal between in-situ casing and completion string. Packers are mechanically complex and require an activation system as well as numerous interactive parts that engage in-situ casing 10 as the body of the packer is compressed to extrude and activate elastomeric seals to accomplish a seal between in-situ casing 10 and completion string 20.

The disclosed invention eliminates the mechanical complexity of installing a packer as well as the additional trip to install a seal between in-situ casing 10 and completion string 20. As discussed earlier, the time to recover the drilling assembly, pick up the heat exchanger and run the geothermal completion string will result in the loss of the borehole due to the liquefaction of the borehole due to the proximal heat of the liquid magma pool. Further, the disclosed invention provides a more robust primary metal-to-metal sealing system vs. an elastomeric seal that is prone to leaking due to extreme thermal conditions and corrosive well bore fluids.

Turning to FIG. 1, the heat-exchanger assembly 40 further includes one or more drilling float valves 170 that are coupled to the bottom of the heat exchanger 40. Float valves 170 are operable to prevent flow back into the geothermal completion string 20. However, although similar in functionality to conventional float valves, the drilling float valves 170 for the disclosed invention utilize larger spring members 176 in order to provide a threshold opening/circulation pressure, for example, on the order of 1,000 psi. Several float valves 170 may be coupled together to provide a means to easily increase desired threshold opening circulation pressure. The bottom of the last float valve 170 in the string of float valves 170 is securely coupled to bit 180, including by threaded engagement of male and female ends. An expendable sheath 185 comprised of Ultra-High Molecular Weigh Polyethylene (UHMW-PE) or similar material is provided over the bit 180 to ensure that metal to metal sealing surface of in-situ casing interior mating surface profile 75 is not damaged when the drilling bit 180 passes through in-situ casing interior mating surface profile 75.

Turning to the method of operation, the primary goal of the disclosed one-trip system is to conventionally drill rock formation 15 with geothermal completion string 20, heat exchanger 40, bit 180, penetrate liquid magma pool 210 and contemporaneously install, anchor and seal a high-temperature heat exchanger 40 into said magma pool to harvest geothermal energy.

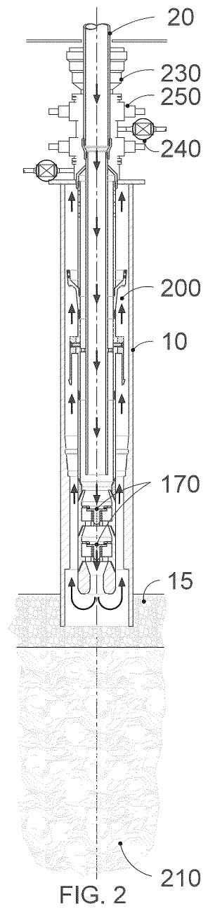

FIGS. 2-5 depict the various stages of the geothermal completion string in accordance with the aforementioned embodiments being drilled into the liquid magma reservoir and deploying the heat exchanger 40.

As detailed in FIG. 1, it is assumed that in-situ casing 10 is set above liquid magma 210 into rock formation 15.

FIG. 2 is a similar view of FIG. 1 with an annular preventor 230 and blow-out preventors (BOP's) 250 equipped with side outlet valves 240. The assembly has been “run in hole” and drills the rock formation 15 above the magma pool 210 During that time, expendable sheath 185 has been removed by this drilling process and has been circulated out of the hole through drilling fluid returns 200. The flow of the drilling fluid through the assembly is symbolized by the arrows in the figure.

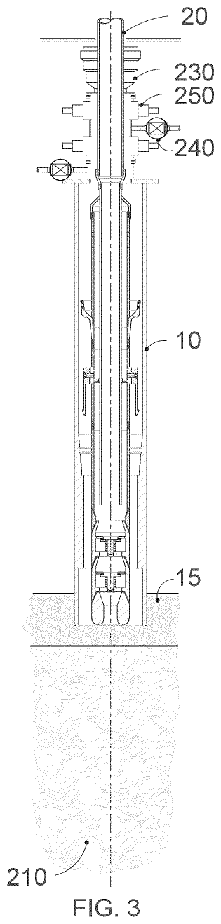

FIG. 3 is a view of FIG. 2 when liquid magma 210 is encountered. This is immediately noted at the top side drilling rig as the completion string 20 can be lowered with no resistance. At this stage, all pumping operations are terminated.

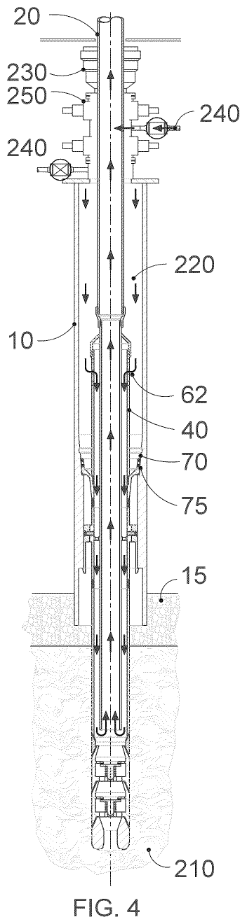

FIG. 4 is a view of FIG. 3 with all pumping stopped-heat exchanger assembly 40 is now lowered into liquid magma 210 with rotation only until lock and sealing assembly 70 fully engages with in-situ mating surface profile 75. Further weight is applied by lowering geothermal completion string 20 to activate, and lock/ratchet the metal-to-metal seals as disclosed in the foregoing embodiments for the lock and sealing assembly 70.

Heat exchanger 40, now immersed into liquid magma 210, begins increasing in temperature due the proximal heat of liquid magma pool 210; fusible ports 66 mounted inside fusible annular seal ring 65 melt, enabling reverse circulation from reversing fluid 220, by closing annular preventor 230, pumping through blow-out preventor (“BOP”) side outlet 240, and taking returns through geothermal completion string 20. This provides cooling of heat exchanger 40 to prevent potential deterioration of metallurgical properties due to the proximal heat of the magma.

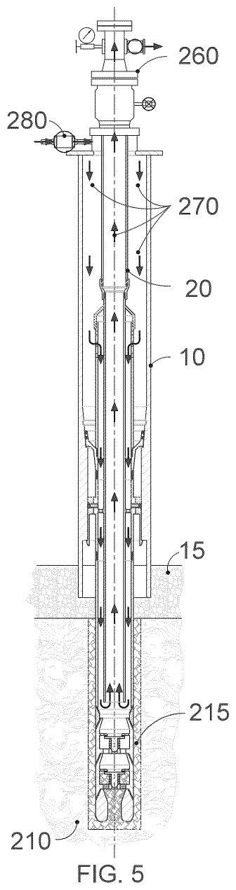

FIG. 5 is a sectional view of FIG. 4 with the blow-out preventors (BOP's) 250 removed, the geothermal completion string 20 tensioned appropriately to account for geothermal thermal expansion, a conventional seal assembly is installed inside casing head and geothermal wellhead (Christmas Tree) 260 is installed, employing practices and methods known and employed in the art.

Geothermal fluid 270 can now be reverse circulated through casing head side outlet 280 through heat exchanger 40 taking returns through geothermal completion string 20 and geothermal wellhead 260 to harvest magma-geothermal energy in the form of high-pressure steam that can be converted to electricity. For example, harvesting of magma thermal energy can be accomplished by piping the resultant high-pressure steam that has been converted from geothermal fluid 270 via reverse circulation through heat exchanger 40 through steam turbines coupled to electrical generators, connected to an electrical grid system. Alternatively, the heat from the harvested high-pressure steam can be used to power other machinery or provide heat for other industrial processes.

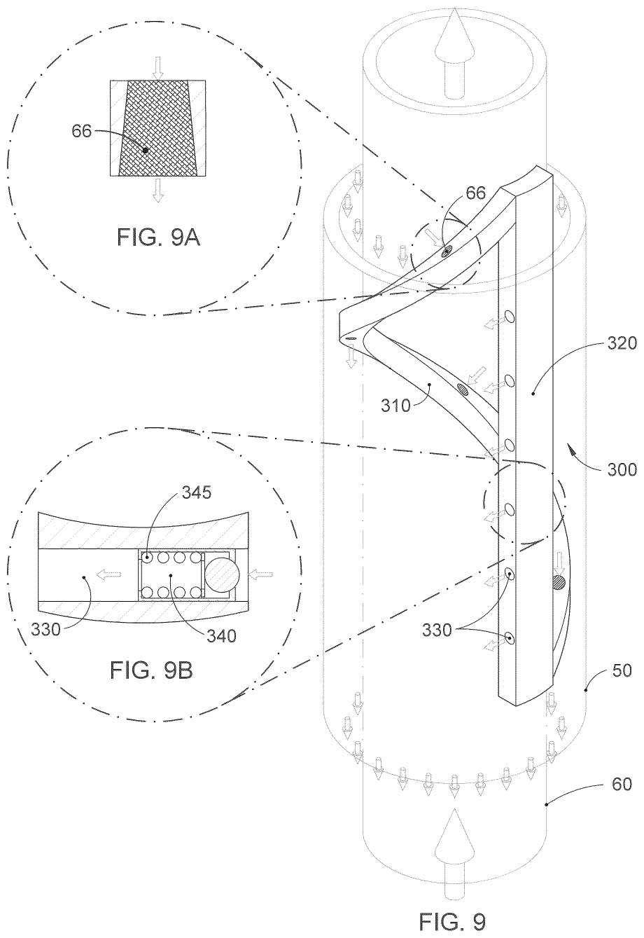

FIG. 9 depicts an alternative embodiment to the fusible annular seal ring 65 detailed in FIG. 6. This alternative embodiment includes a helical member 310 and an annular vertical member 320 that form a hybrid annular sealing system 300 operable to provide “on-demand” conventional circulation or reverse circulation by manipulating applied surface pressures on the drill pipe and/or annulus.

The hybrid annular sealing system 300 includes both a helical member 310 and a vertical member 320 disposed between the inner tube 60 and outer tube 50. This can be accomplished by a thermally activated interference fit. For example, hybrid annular sealing system 300 can be an integrally machined helical member 310 and vertical member 320 into a threaded sub that threads onto the inner tube 60. Outer tube 50 is heated and placed over these components and allowed to cool, completing a thermal interference fit enabling a metal-to-metal sealing system between inner tube 60, hybrid annular sealing system 300 and outer tube 50.

As detailed in FIG. 9A, helical member 310 has a plurality of fusible ports 66, similar to fusible annular seal ring 65 (shown in FIG. 6). As detailed in FIG. 9B, vertical member 320 includes a plurality of mechanical reverse circulating ports 330 that have pressure-activated mechanical valves 340. While the hybrid annular sealing system 300 includes both spring-loaded, pressure-activated mechanical valves 340 and fusible annular ports 66, it is understood that the hybrid annular sealing system 300 could function with only the mechanical reverse circulating ports 330 and pressure-activated valves 340.

The hybrid annular sealing system 300 allows conventional circulation to be established to drill rock formation 15 above magma pool 210 until liquid magma is encountered; at that time conventional circulation is stopped, the annular preventor 230 is closed and reverse circulation through BOP side outlet valve 240 is initiated to cool heat exchanger 40 as shown in FIG. 4. This process allows the heat exchanger 40 to be safely lowered/rotated into the liquid magma pool 210 without external circulation to prevent sticking of heat exchanger 40 that can result as liquid magma 210 is cooled/crystallized above the drilling/heat-exchanger assembly from conventional, external circulation. This allows successful landing/sealing of the locking and seal assembly 70 to fully engage with in-situ mating surface profile 75.

The novelty of hybrid annular sealing system 300 as described above, allows an effective methodology in the event that unexpected, solid, non-molten strata is encountered in the magma pool prior to landing/sealing of the lock and sealing assembly 70 with in-situ mating surface profile 75, as described below.

In the event that a strata of non-molten rock is encountered prior to landing/sealing of lock and sealing assembly 70 to in-situ mating surface profile 75, geothermal completion string 20 can be pulled to the top of the initially encountered liquid magma pool 210, whereby the repetitive drill-quench process as described in the Sandia Report and incorporated herein by reference can be employed using conventional circulation to quench/drill the magma above the solid, non-molten strata to provide a solid wellbore to enable conventional drilling/circulation operations through the solid, non-molten strata.

Once the unexpected solid, non-molten strata is fully penetrated by the bit 180 using conventional circulation, lowering of the heat exchanger can commence by stopping conventional circulation (that tends to stick the assembly as the liquid magma cools/crystallizes above the drilling/heat-exchanger assembly due to cooling from the drilling fluid) and then closing the annular preventor 230, activating pressure-activated mechanical valves 340 and initiating reverse circulation through BOP side outlet 240 to cool the heat exchanger 40 as needed within acceptable thermal metallurgical limits.

The pressure-activated mechanical valves 340 are configured with springs 345 so that reverse circulation through heat exchanger 40 can be accomplished by maintaining pressures above the opening pressure of the pressure-activated mechanical valves 340 but below the aforementioned opening pressure of float valves 170. Note that fusible seals 66 provide annular hydraulic isolation in conjunction with pressure activated valves 340 that comprise a “check-valve” apparatus to complete the annular hydraulic isolation of heat exchanger 40. This methodology enables conventional circulation when required to drill unexpected solid non-molten strata in magma pool 210.

For example, if float valves 170 are configured to have an opening threshold pressure of 1,000 psi by sizing float valves 170 and float valve springs 176 appropriately, the pressure-activated mechanical valves 340 may be configured with springs 345 so that their opening pressure is on the order of 400 psi. Therefore, reverse circulation through heat exchanger 40 can be attained with pressures between 400 and 1,000 psi to penetrate liquid magma. If a solid, non-molten strata is encountered, conventional circulation can be attained by applying threshold pressures above 1,000 psi to quench-drill the magma and establishing circulation through geothermal completion string 20.

Thus, by sizing drilling float valves 170 and drilling float valve springs 176 and annular spring-loaded valves 340 and corresponding springs 345 accordingly, this methodology provides a novel repetitive, “on demand” system operable by pressures and surface equipment manipulation to either (i) drill rock formation 15 above liquid magma or quench-drill solid, non-molten strata by conventional circulation or (ii) penetrate liquid magma by reverse circulation through heat exchanger 40 or (iii) enable landing landing/sealing of lock and sealing assembly 70 so that it can fully engaged with in-situ mating surface profile 75.

This is accomplished by:
(i) pumping down completion string 20, adjusting pump output accordingly so that the threshold pressure to open float valves 170 is attained to drill rock formation 15 above liquid magma 210 or drill non-liquid strata with conventional circulation utilizing the annular hydraulic isolation of fusible seals 66 and pressure-activated mechanical valves 340; or
(ii) closing annular preventor 230 and opening BOP side outlet 240, adjusting pump output accordingly to open pressure-activated mechanical valves 340 to enable reverse circulation to cool the heat exchanger as it is lowered into liquid magma, but limiting pump pressure below threshold opening pressure of float valves 170 thereby preventing drilling fluid from contacting liquid magma which can crystallize above the bit and stick the assembly.

When the landing/sealing of lock and sealing assembly 70 is fully engaged with in-situ mating surface profile 75, reverse circulation is stopped until the heat from liquid magma pool melts the annular fusible ports 66, thereby allowing increased circulation rates.

As the harvesting of geothermal energy is accomplished by pumping geothermal fluid 270 through the heat exchanger 40 immersed in the magma pool, thereby converting geothermal fluid to 270 to high-pressure steam, cooling of liquid magma 210 will create a circumferential tube of crystallized magma 215 around heat exchanger 40, sealing the bottom of bit 180 as well as around heat exchanger 40. This subsequent sealing mechanism eliminates the need to limit reversing pressures below opening threshold pressures of float valves 170, allowing higher reversing flow rates through heat exchanger 40 to increase thermal harvesting efficiency of liquid magma pool 210.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A heat exchanger assembly for in situ casing used in geothermal heat energy extraction comprising:
a heat exchanger comprising an inner tube disposed within an outer tube, wherein the inner tube has an open bottom, and the outer tube has a closed bottom that extends beyond the open bottom of the inner tube,
a lock and sealing assembly operable to secure the heat exchanger to the in-situ casing,
an annular seal ring disposed between the inner tube and outer tube, wherein the fusible annular seal ring comprises at least one fusible port, the fusible port is filled with a low-melting point material, and
one or more float valves disposed at a bottom of the heat exchanger, wherein the one or more float valves are operable to prevent backflow into the heat exchanger.

2. The heat exchanger assembly of claim 1, wherein the lock and sealing assembly comprises a top locking mechanism and a bottom locking mechanism.

3. The heat exchanger assembly of claim 2, wherein the top locking mechanism comprises a conical sealing cone with a tapered exterior surface that terminates at a bottom ledge.

4. The heat exchanger assembly of claim 3, wherein the bottom ledge has a serrated bottom surface.

5. The heat exchanger assembly of claim 2, wherein the bottom locking mechanism comprises a locking collet sleeve having a plurality of pairs of collet fingers configured to flex inward towards the heat exchanger, wherein each of the pairs of collet fingers comprise different lengths.

6. The heat exchanger assembly of claim 5, wherein each of the pairs of pairs of collet fingers comprises a lip.

7. The heat changer assembly of claim 6, wherein the lip is operable to engage an overhang disposed along the interior of the in-situ casing.

8. The heat exchanger assembly of claim 1, wherein the annular seal ring further comprises a hybrid annular sealing system having a helical member and a vertical member, wherein the at least one fusible port are located on the helical member, and the vertical member comprises a plurality of mechanical reverse circulating ports with each port having a pressure-activated mechanical valve.

9. The heat exchanger assembly of claim 8, wherein the one or more float valves each comprise an opening threshold pressure, and wherein each of the plurality of pressure-activated mechanical valves have a threshold opening pressure that is less than the opening threshold pressure of the one more float valves.

10. A system comprising:
a pre-installed in situ casing comprising a mating surface profile and a bottom ledge, and a
heat exchanger assembly comprising a heat exchanger and a lock and sealing assembly, wherein the lock and sealing assembly is operable to secure the heat exchanger to the in-situ casing.

11. The system of claim 10, wherein the lock and sealing assembly comprises a top locking mechanism and a bottom locking mechanism.

12. The system of claim 11, wherein the top locking mechanism comprises a conical sealing cone with a tapered exterior surface that terminates at a bottom ledge, wherein the tapered exterior surface of the conical sealing cone engages the mating surface profile of the in-situ casing, and wherein the bottom ledge of the conical sealing cone engages the bottom ledge of the in-situ casing.

13. The system of claim 10, wherein the bottom ledge has a serrated bottom surface.

14. The system of claim 11, wherein the bottom locking mechanism comprises a locking collet sleeve having a plurality of pairs of collet fingers configured to flex inward towards the heat exchanger, wherein each of the pairs of collet fingers comprise different lengths.

15. The system of claim 14, wherein each of the pairs of pairs of collet fingers comprises a lip, wherein the lip is operable to engage an overhang of the in-situ casing to prevent vertical displacement of the heat exchanger assembly when a pair of collet fingers extend outward.

16. The system of claim 10, wherein the heat exchanger comprises an inner tube disposed within an outer tube, wherein the inner tube has an open bottom and the outer tube has a closed bottom that extends beyond the open bottom of the tube, an annular seal ring disposed between the inner tube and outer tube, wherein the annular seal ring comprises at least one fusible port, the fusible port is filled with a low-melting point material.

17. The system of claim 16 comprising at least one float valve disposed at the bottom of the heat exchanger, wherein the at least one float valve is operable to prevent backflow into the heat exchanger.

18. The system of claim 16, wherein the annular seal ring further comprises a hybrid annular sealing system having a helical member and a vertical member, wherein the at least one fusible port are located on the helical member, and the vertical member comprises a plurality of mechanical reverse circulating ports with each port having a pressure-activated mechanical valve.

19. The system of claim 18, wherein the one or more float valves each comprise an opening threshold pressure, and wherein each of the plurality of pressure-activated mechanical valves have a threshold opening pressure that is less than the opening threshold pressure of the one more float valves.

20. A method for extracting geothermal heat energy comprising the steps of:
providing a pre-installed in situ casing configured to access a liquid magma pool,
providing a geothermal completion string,
providing a drill bit,
providing a heat exchanger assembly coupled to the drill bit and the geothermal completion string,
wherein the heat exchanger assembly comprises a heat exchanger and an annular seal ring disposed between an inner tube and outer tube of the heat exchanger,
wherein the annular seal ring comprises one or more pressure-activated mechanical valves configured to have a threshold opening pressure,
providing one or more float valves disposed at a bottom of the heat exchanger, wherein the one or more float valves are configured to have an opening threshold pressure and are operable to prevent backflow into the heat exchanger when an applied surface pressure exceeds the opening threshold pressure, wherein the threshold opening pressure of the one or more pressure-activated mechanical valves is less than the opening threshold pressure of the one or more float valves and defines a pressure differential range,
manipulating the applied surface pressure to allow either reverse circulation through the heat exchanger when the applied surface pressure is within the pressure differential range or allow conventional circulation through the heat exchanger and geothermal completion string when the applied surface pressure exceeds the pressure differential range, and
drilling through strata utilizing conventional circulation,
and penetrating into the liquid magma pool utilizing reverse circulation.

21. The method of claim 20, wherein the heat exchanger assembly further comprises a lock and sealing assembly operable to secure the heat exchanger assembly to the in-situ casing.

22. The method of claim 21 wherein the annular seal ring further comprises at least one fusible port, the fusible port is filled with a low-melting point material.

23. The method of claim 22 further comprising the step of locking the heat exchanger assembly in place using the lock and sealing assembly at a distance from the liquid magma pool such that the heat from the liquid magma pool melts the low-melting point material within the at least one fusible port.

24. The method of claim 23 further comprising the step of closing an annular preventer and pumping reversing fluid through the heat exchanger.

25. The method of claim 23 further comprising the step of installing a geothermal wellhead.

26. The method of claim 25 further comprising the step of circulating a geothermal fluid through the heat exchanger to harvest magma geothermal energy.

27. The method of claim 25 further comprising the step of cooling the liquid magma until a seal of crystallized magma is formed around the heat exchanger and drill bit.

28. A system comprising:
a pre-installed in situ casing comprising a mating surface profile terminating at a bottom ledge and an overhang beneath the bottom ledge, and a
completion string comprising a lock and sealing assembly having a top locking mechanism operable to create a seal between the completion string and the mating surface profile of the in-situ casing, and a bottom locking mechanism operable to secure the completion string to the overhang of the in-situ casing to prevent vertical displacement of the completion string.

29. The system of claim 28, wherein the top locking mechanism comprises a conical sealing cone with a tapered exterior surface that terminates at a bottom ledge, wherein the tapered exterior surface of the conical sealing cone engages the mating surface profile of the in-situ casing, and wherein the bottom ledge of the conical sealing cone engages the bottom ledge of the in-situ casing.

30. The system of claim 28, wherein the bottom locking mechanism comprises a locking collet sleeve having a plurality of pairs of collet fingers each having a lip at its distal end, wherein the plurality of pairs of collet fingers are configured to flex inward towards the drill string assembly, wherein each of the pairs of collet fingers comprise different lengths, wherein the lip is operable to engage the overhang of the in situ casing.
